(19) United States
(12) Patent Application Publication
(10) Pub. No.: US 2026/0365863 A1
(43) Pub. Date: Nov. 19, 2026

(54) CARBON FIBER-REINFORCED RESIN-BASED COMPOSITE COATING, METHOD FOR PREPARING THE SAME, AND USE THEREOF

(71) Applicants: SHANDONG UNIVERSITY OF SCIENCE AND TECHNOLOGY, Qingdao (CN); QINGDAO SHANKE MARINE ENVIRONMENTAL ENGINEERING CO., LTD., Qingdao (CN); OCEAN UNIVERSITY OF CHINA, Qingdao (CN)

(72) Inventors: Xiaoping HU, Qingdao (CN); Hongzhi CUI, Qingdao (CN); Chengbao LIU, Qingdao (CN); Jiliang ZHANG, Qingdao (CN); Huazhang LI, Qingdao (CN); Chunyu ZHAO, Huludao (CN); Yuhao ZHANG, Qingdao (CN); Zhihao DING, Qingdao (CN); Baokun HAN, Qingdao (CN); Li CHENG, Qingdao (CN); Teng XUE, Qingdao (CN); Changjiang MA, Qingdao (CN); Changfu SUN, Qingdao (CN); Jiakai WANG, Chengdu (CN)

(21) Appl. No.: 19/679,890

(22) Filed: May 18, 2026

(30) Foreign Application Priority Data
May 19, 2025 (CN) 2025106433461

(51) Int. Cl. C09D 7/62; C08J 5/24; C09D 7/40; C09D 7/80; C09D 163/00; F16L 58/02

(52) U.S. Cl. CPC C09D 7/62; C08J 5/248; C09D 7/70; C09D 7/80; C09D 163/00; F16L 58/02; C08J 2363/00; C08J 2495/00

(57) ABSTRACT

The present invention discloses a carbon fiber-reinforced resin-based composite coating and a method for preparing the same. The method comprises: immersing carbon fiber that has been pretreated in a curing agent to obtain a curing-agent mixture containing wetted carbon fiber; mixing an epoxy resin, bitumen, diaminodiphenylmethane, and glycidyl ether, and then mixing the resulting mixture with the curing-agent mixture to obtain a resin mixture; coating the resin mixture onto a pretreated substrate surface, and curing at room temperature. The resulting composite coating can be used for repair, protection, or sealing of a pipeline surface.

### CROSS-REFERENCE TO RELATED APPLICATIONS

The present application claims priority to Chinese Patent Application No. 202510643346.1, filed with the China National Intellectual Property Administration on May 19, 2025, and entitled “Carbon Fiber-Reinforced Resin-Based Composite Coating, Method for Preparing the Same, and Use Thereof,” the entire disclosure of which is incorporated herein by reference and made a part hereof for all purposes.

### TECHNICAL FIELD

The present invention belongs to the technical field of pipeline corrosion protection and, in particular, relates to a carbon fiber-reinforced resin-based composite coating, a method for preparing the same, and use thereof.

### BACKGROUND OF THE INVENTION

The information disclosed in this background section is intended merely to enhance understanding of the general background of the present invention, and should not necessarily be construed as an admission or any form of suggestion that such information constitutes prior art that has already become known to a person of ordinary skill in the art.

With an increase in the service life of pipelines, some old pipeline networks suffer from corrosion thinning and even leakage, and sealing operations are often required. However, conventional pipeline repair methods often have problems such as a large impact on construction, long shutdown time, low repair efficiency, high safety risks, and slow response, and thus cannot meet the urgent demand of modern oil and gas pipelines for rapid, efficient, and safe operation. Therefore, it is necessary to develop a novel rapid pipeline sealing technology.

Rapid pipeline sealing technology can rapidly and effectively seal a leakage location of a pipeline without interrupting transmission, thereby greatly shortening repair time and improving repair efficiency. At present, rapid pipeline sealing technology has formed various mature methods and technical systems. Among them, technologies for external repair of pipelines mainly include a clamp sealing method and a repair-adhesive sealing method. In the pipeline clamp sealing method, a specially designed pipeline clamp is used, sleeved onto a pipeline, and two clamps are tightly fixed together with bolts, thereby effectively sealing the pipeline. This technology is applicable to cases where the pipeline has a relatively small diameter, and in a humid and hot environment, the clamp is prone to corrosion, resulting in secondary leakage. In the repair-adhesive sealing method, it is only necessary to apply a resin adhesive to a damaged portion or leakage point of a pipeline and allow the resin adhesive to naturally cure, thereby forming a firm sealing layer. This method is easy to operate and is applicable to pipelines made of various materials and having various sizes. However, conventional polymer resin adhesives still have problems such as a low curing rate, relatively high brittleness after curing, poor corrosion resistance in harsh environments, and strength and toughness properties failing to meet requirements, which limits their application in the field of rapid pipeline sealing.

Fiber materials are widely used in polymer coatings due to their high strength, good flexibility and toughness, corrosion resistance, and diversified application forms. Fiber materials, such as glass fibers and polyester fibers, can generally withstand relatively large tensile and compressive forces, and are suitable for application scenarios requiring high load-bearing capability, such as pipeline repair and reinforcement. In addition, fiber materials can be bent and twisted to a relatively large extent without being easily broken, so that when they are used to fill gaps or wrap pipelines, they can closely conform to the pipelines and reduce the possibility of shrinkage deformation and cracking. Meanwhile, fiber materials also have good corrosion resistance, can resist erosion by chemical substances, and can maintain long-term stability and durability. Finally, fiber materials may exist in forms such as fiber cloth, fiber tape, or fiber rope, are convenient for construction and operation, and are easy to use in combination with other materials, such as resins, to form composite materials, which facilitates the application of fiber-material composites in the field of rapid pipeline sealing.

### SUMMARY OF THE INVENTION

To overcome deficiencies in the prior art, an object of the present invention is to provide a carbon fiber-reinforced resin-based composite coating, a method for preparing the same, and use thereof. With respect to a rapid-curing coating system, carbon fibers (CFs) are introduced into an epoxy resin (EP) coating to investigate interfacial bonding between the CFs and the resin, and the filling of defects, such as pores and cracks, in the resin coating by the CFs, to analyze the effects of the CFs on the strength and toughness, corrosion resistance, and bonding strength of the composite coating, and to clarify advantages of the composite coating in application to rapid pipeline sealing technology.

To achieve the above objective, the technical solutions of the present invention are as follows:

in a first aspect, the present invention provides a carbon fiber-reinforced resin-based composite coating, comprising the following components in parts by weight: 0.5-2 parts of carbon fiber, 3-5 parts of a curing agent, 8-12 parts of an epoxy resin, 1-1.5 parts of bitumen, 1-2 parts of diaminodiphenylmethane (DDM), and 1-2 parts of glycidyl ether.

In one or more embodiments, the carbon fiber comprises carbon fiber cloth.

Carbon fiber may be used directly, and carbon fiber cloth may also be used. By comparison, carbon fiber cloth has better performance. In the carbon fiber cloth, the vast majority of carbon fibers are arranged substantially in parallel and are arranged relatively tightly. The carbon fibers have relatively uniform thicknesses, and their diameters are between 4.5 μm and 4.8 μm. The specific texture type of the carbon fiber cloth is not particularly limited; for example, plain weave fabric may be used in the examples.

In one or more embodiments, the curing agent is an amine curing agent, and the amine curing agent includes a polyetheramine curing agent and an aliphatic amine curing agent, preferably a polyetheramine curing agent. The polyetheramine curing agent is one or more of D230, D400, T403, D2000, and T5000, preferably a polyetheramine D400 curing agent.

In one or more embodiments, the epoxy resin includes E51 resin and E44 resin, preferably E51 resin. By virtue of polar groups such as hydroxyl groups and ether bonds, the epoxy resin forms strong chemical bonding and physical anchoring with the carbon fibers, thereby ensuring high interfacial bonding force. After curing, the epoxy resin has a high crosslinking density, imparting high modulus, creep resistance, and fatigue resistance to the coating. Its chemical inertness enables it to withstand acid, alkali, oil and gas corrosive media, and a wide temperature range, and its coefficient of thermal expansion is close to that of metal pipelines, thereby avoiding cracking. During construction, thick coating and uniform coverage of complex curved surfaces can be achieved by adjusting viscosity and thixotropy, and the curing shrinkage is low and highly controllable, thereby ensuring long-term sealing performance. Compared with other resins such as polyester resin, which has poor corrosion resistance and large shrinkage, and polyurethane, which has insufficient temperature resistance, the epoxy system has both high cost performance and mature engineering verification, and thus becomes an optimal choice under harsh operating conditions.

The bitumen has flexibility and ductility, and can effectively counteract the brittleness of the epoxy resin after curing.

Diaminodiphenylmethane contains two active amino groups (—NH₂) in its molecule, and can undergo a ring-opening addition reaction with epoxy groups in the epoxy resin to form hydroxyl groups and carbon-nitrogen bonds, thereby gradually constructing a highly crosslinked three-dimensional network structure, which can improve the mechanical strength, heat resistance, and chemical stability of the composite coating.

In one or more embodiments, the glycidyl ether comprises glycerol triglycidyl ether (GGE). Existing glycidyl ethers, such as butyl glycidyl ether, ethylene glycol diglycidyl ether, propoxylated glycerol glycidyl ether, and 1,4-butanediol diglycidyl ether, are generally inferior to glycerol triglycidyl ether. The specific reasons are as follows: a glycerol triglycidyl ether molecule contains three epoxy groups (C₁₂H₂₀O₆), which can simultaneously participate in chain-like and network-like crosslinking reactions during curing, thereby significantly improving the tensile strength, compressive strength, and impact resistance of the coating. Butyl glycidyl ether contains only one epoxy group, has a low crosslinking density, and after curing, the coating has high brittleness and poor temperature resistance. Ethylene glycol diglycidyl ether has relatively insufficient mechanical strength and chemical resistance. Propoxylated glycerol glycidyl ether has a relatively high cost. 1,4-Butanediol diglycidyl ether contains two epoxy groups (C₁₀H₁₈O₄) and forms a chain-like crosslinked structure, which can effectively improve flexibility, but has a relatively low crosslinking density and relatively low mechanical strength.

In the present invention, through dilution, toughening, crosslinking, and regulation of chemical stability, the glycidyl ether solves problems of conventional epoxy resins such as high viscosity, high brittleness, and poor weather resistance.

In a second aspect, the present invention provides a method for preparing the above carbon fiber-reinforced resin-based composite coating, comprising the following steps:
immersing the carbon fiber that has been pretreated in the curing agent to obtain a curing-agent mixture containing wetted carbon fiber;
mixing the epoxy resin, the bitumen, the diaminodiphenylmethane, and the glycidyl ether, and mixing the resulting mixture with the curing-agent mixture containing wetted carbon fiber to obtain a resin mixture; and
coating the resin mixture onto a pretreated substrate surface, and curing at room temperature to obtain the carbon fiber-reinforced resin-based composite coating.

In one or more embodiments, the specific steps for pretreating the carbon fiber comprise: immersing the carbon fiber in an acid solution, allowing the carbon fiber to stand, taking out the carbon fiber, and cleaning the carbon fiber, thereby obtaining the carbon fiber that has been pretreated.

Preferably, the acid solution has a pH of 5-6.

Preferably, the standing time is 6-12 h.

Preferably, the cleaning comprises cleaning sequentially with water and absolute ethanol, for the purpose of cleaning off residual acid solution on the surface of the carbon fiber.

In one or more embodiments, before pretreating the carbon fiber, the carbon fiber is further cleaned and dried. Specifically, surface impurities are cleaned with absolute ethanol, and after drying, clean and dry carbon fiber is obtained.

In one or more embodiments, when the carbon fiber that has been pretreated is immersed in the curing agent, a standing step for sufficient mixing is performed for 1-3 h.

In one or more embodiments, the resin mixture is further required to be placed in a vacuum drying environment and evacuated for 5-10 min, so as to eliminate bubbles generated during the curing reaction.

In one or more embodiments, with respect to the pretreated substrate surface, a substrate surface is pretreated by polishing, cleaning, and drying. The specific steps comprise polishing the substrate surface with sandpaper, cleaning the substrate surface with acetone and ethanol by ultrasonic vibration, wiping the substrate surface clean, and drying the substrate surface for later use.

In one or more embodiments, the curing time at room temperature is 20-40 min.

In a third aspect, the present invention provides use of the above carbon fiber-reinforced resin-based composite coating in a pipeline, preferably use in rapid pipeline sealing.

The carbon fiber-reinforced resin-based composite coating prepared by the present invention has a relatively high curing rate, and relatively good corrosion resistance, mechanical properties, and adhesion properties, and can be used in scenarios of repair, protection, reinforcement, and sealing of pipeline surfaces.

In a fourth aspect, the present invention provides a pipeline, comprising the above carbon fiber-reinforced resin-based composite coating.

One or some of the above technical solutions have the following advantages or beneficial effects.

(1) The presence of the CFs prevents directional propagation of cracks, so that uneven and irregular fracture occurs on the fracture surface of the CFs@EP composite coating, and the interfacial bonding between the CFs and EP is relatively tight, which is beneficial to improving the mechanical properties of the composite coating. The presence of the CFs significantly increases the glass transition temperature and thermal stability of the resin, which helps the CFs@EP composite coating to be applied under more severe operating conditions. The introduced CFs can significantly increase the anti-permeation performance of the coating and provide long-term corrosion protection capability. Therefore, the CFs@EP composite coating, namely a carbon fiber-epoxy resin composite coating, prepared at room temperature in the present invention has a relatively high curing rate and excellent corrosion resistance and strength and toughness properties, can be applied to rapid pipeline sealing under harsh environments, and provides an idea for its application in the field of oil and gas pipeline repair.

(2) The commercial resin reference sample used for comparison and the CFs@EP resin prepared by the present invention both exhibited good fluidity after preparation. However, when tilted again after standing for 30 min, compared with the commercial resin reference sample used for comparison, the CFs@EP resin had already lost fluidity, whereas the commercial resin reference sample used for comparison still exhibited good fluidity, indicating that the CFs@EP resin has a relatively high curing rate.

(3) Compared with the pure EP coating, the composite coating containing the CFs exhibits a higher impedance value. As the immersion time increases, the phase angle of the pure EP coating decreases significantly after 30 days. However, during an immersion process of 50 days, the phase of the CFs@EP composite coating is always maintained at a relatively high position. Compared with the pure EP coating, although the radius of the capacitive arc of the CFs@EP composite coating shows a decreasing trend, its capacitive-arc radius is still one order of magnitude higher than that of pure EP. Therefore, the introduced CFs can significantly increase the anti-permeation performance of the coating and provide long-term corrosion protection capability.

(4) After a 60-day neutral salt-spray test, no obvious corrosion product was found in the composite coating into which the CFs were introduced, and no obvious change occurred in the coating color, indicating that the relatively tightly arranged CFs effectively improved the barrier capability of the coating, significantly improved the anticorrosion performance of the composite coating, and effectively improved the environmental adaptability of the carbon fiber-reinforced resin-based composite coating in pipeline sealing.

(5) The bonding force of the CFs@EP composite coating reached up to 17.95 MPa, indicating that the CFs can effectively enhance the adhesion of the coating and enable the CFs@EP composite coating to have superior anticorrosion performance. The tensile strength of the CFs@EP composite coating increased to 241.67 MPa, and the elongation at break reached 269.8%, indicating that the high strength and toughness of the CFs themselves made a relatively large contribution to the improvement of the tensile strength of the composite coating. In the falling-weight impact test, when the impact hammer heights were 30 cm, 50 cm, and 70 cm, no crack was generated at the center of the CFs@EP composite coating, indicating that the CFs significantly improved the brittleness problem of the coating after curing and greatly improved the impact resistance of the composite coating.

### BRIEF DESCRIPTION OF THE DRAWINGS

The accompanying drawings, which constitute a part of the specification, are used to provide a further understanding of the present invention. The illustrative embodiments of the present invention and the description thereof are used to explain the present invention, and do not constitute an improper limitation on the present invention.

FIG. 1A to FIG. 1C are scanning electron microscopy (SEM) images showing the surface morphology of carbon fibers at different magnifications.

FIG. 1D is an energy-dispersive spectroscopy (EDS) elemental distribution map of carbon fibers.

FIG. 2 shows attenuated total reflection-Fourier transform infrared (ATR-FTIR) spectra of a pure EP coating and a CFs@EP composite coating.

FIG. 3A and FIG. 3B are SEM images showing brittle-fracture cross-sections of the pure EP coating at different magnifications.

FIG. 3C and FIG. 3D are SEM images showing brittle-fracture cross-sections of the CFs@EP composite coating at different magnifications.

FIG. 4A is a state comparison image of a commercial resin reference sample used for comparison, namely Phoenix-brand E44 epoxy resin, and CFs@EP resin at a curing time of 0 min; wherein, in the direction shown in FIG. 4A, the sample at the lower left is the commercial resin reference sample used for comparison, and the sample at the upper right is the CFs@EP resin.

FIG. 4B is a state comparison image of a commercial resin reference sample used for comparison, namely Phoenix-brand E44 epoxy resin, and the CFs@EP resin at a curing time of 30 min; wherein, in the direction shown in FIG. 4B, the sample at the lower left is the commercial resin reference sample used for comparison, and the sample at the upper right is the CFs@EP resin.

FIG. 5 shows differential scanning calorimetry (DSC) curves of the pure EP coating and the CFs@EP composite coating of the present invention.

FIG. 6A is a Bode impedance modulus plot of the pure EP coating, in which the coordinate axes represent immersion time, logarithm of frequency, and logarithm of impedance modulus; different curves or symbols respectively represent test results of the coating after immersion for 5 days, 15 days, 30 days, and 50 days.

FIG. 6B is a Bode phase angle plot of the pure EP coating, in which the horizontal coordinate is the logarithm of frequency and the vertical coordinate is phase angle; different curves or symbols respectively represent test results of the coating after immersion for 5 days, 15 days, 30 days, and 50 days.

FIG. 6C is a Nyquist plot of the pure EP coating, in which the coordinate axes represent the real part of impedance, the imaginary part of impedance, and immersion-time-related parameters; different curves or symbols respectively represent test results of the coating after immersion for 5 days, 15 days, 30 days, and 50 days.

FIG. 6D is a Bode impedance modulus plot of the CFs@EP composite coating, in which the coordinate axes represent immersion time, logarithm of frequency, and logarithm of impedance modulus; different curves or symbols respectively represent test results of the coating after immersion for 5 days, 15 days, 30 days, and 50 days.

FIG. 6E is a Bode phase angle plot of the CFs@EP composite coating, in which the horizontal coordinate is the logarithm of frequency and the vertical coordinate is phase angle; different curves or symbols respectively represent test results of the coating after immersion for 5 days, 15 days, 30 days, and 50 days.

FIG. 6F is a Nyquist plot of the CFs@EP composite coating, in which the coordinate axes represent the real part of impedance, the imaginary part of impedance, and immersion-time-related parameters; different curves or symbols respectively represent test results of the coating after immersion for 5 days, 15 days, 30 days, and 50 days.

FIG. 7A shows optical photographs of a commercial resin reference coating used for comparison after 7 days, 30 days, and 60 days in a neutral salt-spray test.

FIG. 7B shows optical photographs of the pure EP coating after 7 days, 30 days, and 60 days in the neutral salt-spray test.

FIG. 7C shows optical photographs of the CFs@EP composite coating after 7 days, 30 days, and 60 days in the neutral salt-spray test.

FIG. 8A is a comparison diagram of adhesion test results of the pure EP coating and the CFs@EP composite coating, in which the horizontal coordinate is coating type and the vertical coordinate is bonding force, in MPa.

FIG. 8B is a physical-result photograph of the pure EP coating after an adhesion test.

FIG. 8C is a physical-result photograph of the CFs@EP composite coating after an adhesion test.

FIG. 9A is a comparison diagram of stress-strain curves of the pure EP coating and the CFs@EP composite coating.

FIG. 9B is a comparison diagram of tensile strength of the pure EP coating and the CFs@EP composite coating.

FIG. 9C is a comparison diagram of elongation at break of the pure EP coating and the CFs@EP composite coating.

FIG. 10A shows a local result image (upper) and a larger-field result image (lower) of the pure EP coating after impact under a falling-hammer height condition of 30 cm.

FIG. 10B shows a local result image (upper) and a larger-field result image (lower) of the CFs@EP composite coating after impact under a falling-hammer height condition of 30 cm.

FIG. 10C shows a local result image (upper) and a larger-field result image (lower) of the CFs@EP composite coating after impact under a falling-hammer height condition of 50 cm.

FIG. 10D shows a local result image (upper) and a larger-field result image (lower) of the CFs@EP composite coating after impact under a falling-hammer height condition of 70 cm.

### DESCRIPTION OF THE INVENTION

The present application is further described below with reference to specific examples. It should be understood that these examples are provided merely to illustrate the present application and are not intended to limit the scope of protection of the present application. Experimental methods for which specific conditions are not specified in the examples are generally carried out under conventional conditions in the art, in accordance with the operating instructions of corresponding instruments, or in accordance with relevant product manuals.

Unless otherwise defined, technical terms and scientific terms used in the present application have the meanings commonly understood by those skilled in the art. Unless otherwise specified, the reagents, raw materials, and instruments used in the present application are all available through conventional commercial channels and are used according to conventional methods in the art or corresponding product manuals. The specific embodiments, raw materials, amounts, and test conditions described in the present application are merely illustrative, and should not be construed as improperly limiting the scope of protection of the present application.

Unless otherwise specified, the following performance tests are conducted under the same or comparable sample preparation conditions. The pure EP coating, the CFs@EP composite coating, and the coatings of the comparative examples are tested after being prepared according to the corresponding examples or comparative examples. The relevant test results are used to compare the effects of different coating systems or different mixing sequences on coating performance.

The carbon fiber cloth used in the present invention was provided by Toray Industries, Inc. of Japan, model T-300.

In order to enable a person skilled in the art to understand the technical solutions of the present invention more clearly, the technical solutions of the present invention are described in detail below in conjunction with specific examples.

### Example 1

1. Q235 carbon steel having areas of 1 cm² and 10 cm² was polished with 200-mesh and 600-mesh sandpaper, cleaned with acetone and ethanol by ultrasonic vibration, wiped clean, dried, and set aside for later use. It should be noted that the 1 cm² sample was used for electrochemical tests, and the 10 cm² sample was used for salt-spray tests.

2. Before pretreating the CFs, surface impurities were first cleaned from the CFs with absolute ethanol, and after drying, clean and dry CFs were obtained.

3. The CFs were immersed in an aqueous solution prepared from hydrochloric acid (pH=5). After standing for 6 h, the CFs were taken out and sequentially cleaned with deionized water and absolute ethanol to remove residual acid solution on the surfaces of the CFs, thereby obtaining pretreated CFs.

4. 1.5 g of the pretreated CFs was immersed in 4.0 g of a polyetheramine D400 curing agent, and allowed to stand for 1.5 h to allow the CFs and the curing agent to be sufficiently combined.

5. 10 g of E51 resin, 1.25 g of bitumen, 1.5 g of diaminodiphenylmethane, and 1.5 g of glycerol triglycidyl ether were fully mixed. The above mixture was poured into the curing-agent mixture containing wetted CFs, and slowly stirred to allow sufficient mixing. In order to eliminate bubbles generated during the curing reaction, the resin mixture was placed in a vacuum drying oven and evacuated for 5-10 min.

6. The resin mixture was coated onto the pretreated carbon-steel surface using a wire-bar coater, and cured at room temperature for 30 min to obtain a carbon fiber-epoxy resin composite coating, denoted as CFs@EP.

### Example 2

Example 2 was different from Example 1 in that the epoxy resin was E44. The remaining steps and amounts were the same as those in Example 1.

### Comparative Example 1

1. Q235 carbon steel having areas of 1 cm² and 10 cm² was polished with 200-mesh and 600-mesh sandpaper, cleaned with acetone and ethanol by ultrasonic vibration, wiped clean, dried, and set aside for later use.

2. 10 g of E51 resin, 4 g of a polyetheramine D400 curing agent, 1.25 g of bitumen, 1.5 g of diaminodiphenylmethane, and 1.5 g of glycerol triglycidyl ether were fully mixed. In order to eliminate bubbles generated during the curing reaction, the resin mixture was placed in a vacuum drying oven and evacuated for 5-10 min.

3. The resin mixture was coated onto the pretreated carbon-steel surface using a wire-bar coater, and cured at room temperature for 30 min to obtain an epoxy resin-based coating, denoted as EP.

### Comparative Example 2

Comparative Example 2 was different from Example 1 in that, in steps 4 and 5, the addition order of the resin, curing agent, and carbon fiber was different. Specifically, the resin and the curing agent were mixed first, and the carbon fiber was then impregnated. The specific steps were as follows:

E51 resin, bitumen, diaminodiphenylmethane, glycerol triglycidyl ether, and the curing agent were fully mixed according to proportions and allowed to stand, and then the resulting mixture was used to impregnate the carbon fiber to allow sufficient mixing, thereby obtaining a resin mixture. The resin mixture was then placed in a vacuum drying oven and evacuated for 5-10 min.

### Comparative Example 3

Comparative Example 3 was different from Example 1 in that, in steps 4 and 5, the addition order of the resin, curing agent, and carbon fiber was different. Specifically, the carbon fiber, resin, and curing agent were directly mixed. The specific steps were as follows:

E51 resin, bitumen, diaminodiphenylmethane, glycerol triglycidyl ether, the curing agent, and the carbon fiber were fully mixed according to proportions and allowed to stand, thereby obtaining a resin mixture. The resin mixture was then placed in a vacuum drying oven and evacuated for 5-10 min.

### Comparative Example 4

Comparative Example 4 was different from Example 1 in that, in steps 4 and 5, the addition order of the resin, curing agent, and carbon fiber was different. Specifically, the epoxy resin and the carbon fiber were mixed first, and then mixed with the curing agent. The specific steps were as follows:

E51 resin, bitumen, diaminodiphenylmethane, and glycerol triglycidyl ether were fully mixed according to proportions and then immersed into the carbon fiber, and the curing agent was then added, thereby obtaining a resin mixture. The resin mixture was then placed in a vacuum drying oven and evacuated for 5-10 min.

TABLE 1
Comparison of Mechanical Properties of Example 1
and Comparative Examples 1-4

| | Tensile strength | Elongation | Bonding |
|---|---|---|---|
| | (MPa) | at break (%) | force (MPa) |
| Example 1 | 241.67 | 269.8 | 17.95 |
| Comparative | 36.26 | 98.58 | 4.14 |
| Example 1 | | | |
| Comparative | 98.65 | 133.24 | 8.75 |
| Example 2 | | | |
| Comparative | 162.17 | 177.34 | 12.96 |
| Example 3 | | | |
| Comparative | 210.53 | 201.72 | 16.33 |
| Example 4 | | | |

As can be seen from Table 1, compared with Comparative Examples 2-4, the CFs@EP composite coating obtained in Example 1 had higher tensile strength, elongation at break, and bonding force, indicating that the mixing sequence of the carbon fiber, curing agent, and resin system has an effect on the mechanical properties and bonding properties of the composite coating.

In Example 1, the carbon fiber that had been pretreated was first immersed in the curing agent to obtain a curing-agent mixture containing wetted carbon fiber, and then mixed with a mixture formed from the epoxy resin, bitumen, diaminodiphenylmethane, and glycidyl ether. This sequence is beneficial to sufficient contact between the curing agent and the pretreated carbon fiber, and helps the subsequent resin mixture to be sufficiently mixed with the wetted carbon fiber. The results in Table 1 show that the composite coating obtained using this mixing sequence has relatively good bonding properties and mechanical properties.

By contrast, if the epoxy resin and the curing agent are first mixed and the carbon fiber is then added, or if the mixing sequence of the carbon fiber, epoxy resin, and curing agent is changed, sufficient mixing and interfacial bonding between the carbon fiber and the resin system may be affected. The results in Table 1 show that the relevant properties of the coatings obtained in the corresponding comparative examples are lower than those in Example 1.

Without being limited to any particular theory, the above performance differences may be related to the following factors.

Before the curing agent reacts with the resin, its viscosity is relatively low, and the curing agent can more sufficiently wet the carbon fiber surfaces and microscopic pores. In addition, the uncured low-viscosity resin can penetrate into these microstructures, thereby synergistically enhancing interfacial bonding through mechanical interlocking and chemical bonding. By contrast, if the curing agent and the resin are mixed first, the viscosity of the resin system may rapidly increase due to a pre-curing reaction, resulting in insufficient fiber wetting and an increase in interfacial porosity.

For the mixing sequence in which the pretreated carbon fiber is first brought into contact with the resin and the curing agent is subsequently added, oxygen-containing functional groups such as hydroxyl groups and carboxyl groups may be present on the surface of the pretreated carbon fiber, and epoxy groups in the resin may generate interfacial interactions with groups on the fiber surface. When the curing agent is added later, it participates in the curing reaction of the epoxy resin, which may reduce the opportunity for the fiber surface groups to sufficiently interact with the resin system.

The above mechanism explanation is used only to explain possible reasons for the performance differences between the examples and the comparative examples, and should not be construed as a further limitation on the scope of protection of the claims. The technical effects of the present invention are mainly illustrated by Table 1 and the test results of the relevant examples and comparative examples.

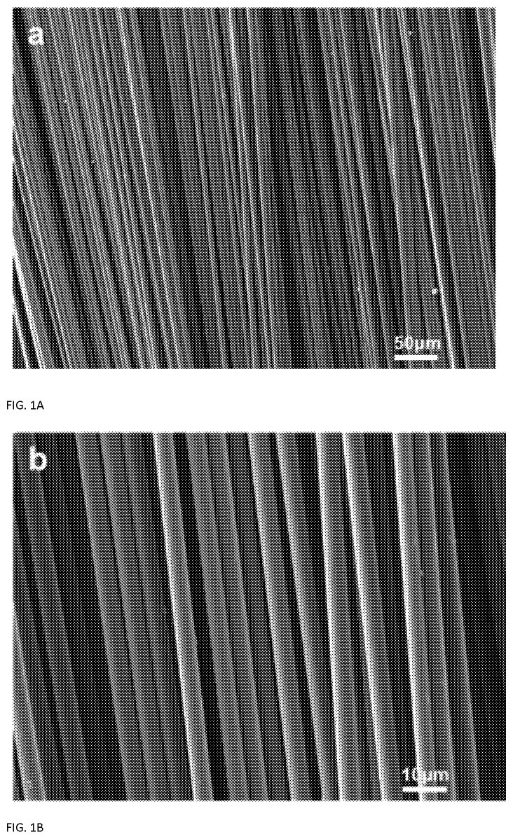

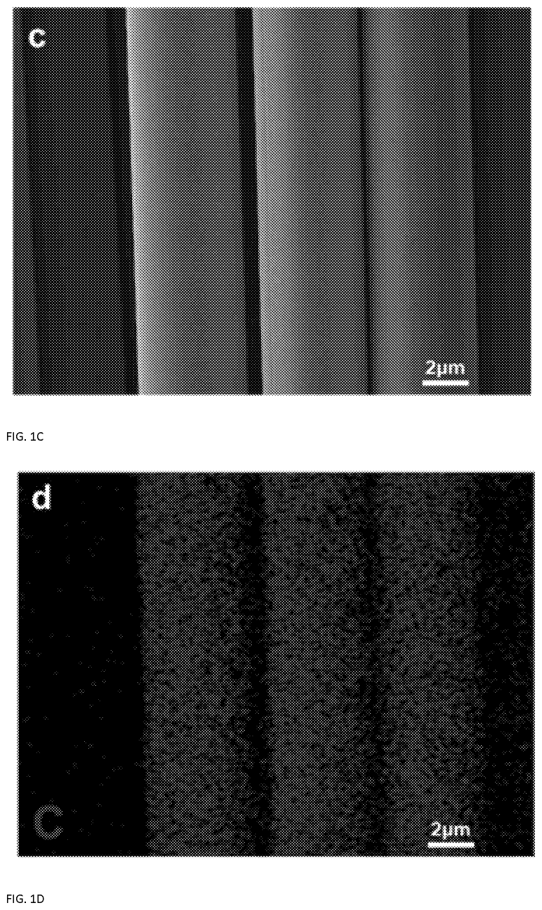

FIG. 1 shows SEM images and an EDS image of the surface morphology of the carbon fibers at different magnifications. As can be seen from FIG. 1A, the vast majority of the carbon fibers are arranged substantially in parallel and are arranged relatively tightly. According to the data statistics in FIG. 1B, the carbon fibers have relatively uniform thicknesses, and their diameters are between 4.5 μm and 4.8 μm. Through further magnification, as shown in FIG. 1C, it can be observed that the surfaces of the carbon fibers are relatively smooth, and after the pretreatment process, a small number of relatively narrow grooves are present along the fiber length direction. In addition, FIG. 1D is an EDS elemental distribution map, showing that the carbon element is mainly distributed in the carbon fiber region.

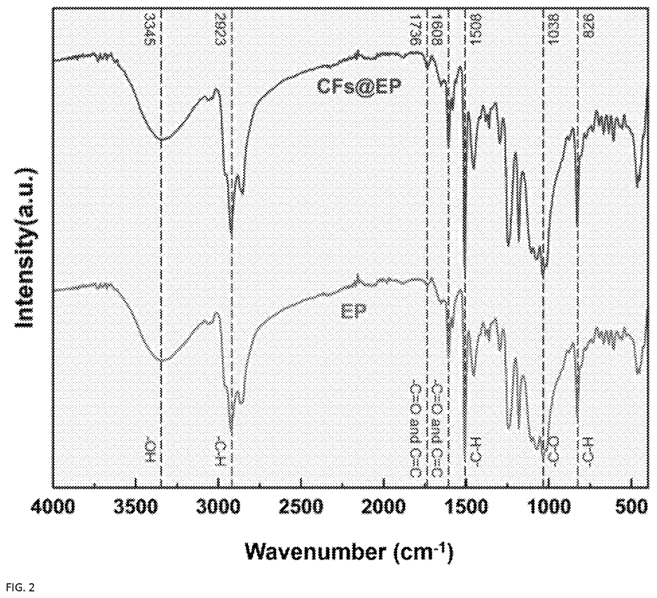

As shown in FIG. 2, in the FTIR spectra of EP and CFs@EP, a typical broad and strong peak can be observed in the range of 3200 to 3600 cm⁻¹, which is caused by O—H stretching vibration of water adsorbed on the resin surface. The peaks at 2923 and 2849 cm⁻¹ are respectively caused by asymmetric stretching and symmetric stretching vibrations of methylene —C—H, and the peaks at 1508 and 826 cm⁻¹ are attributed to methyl —C—H stretching vibration. Typical absorbance peaks at 1736, 1608, and 1038 cm⁻¹ are respectively caused by —C═O, C═C, and —C—O stretching vibrations in the epoxy coating. In addition, due to stretching vibrations of —C—H and —C—O in the CFs, a significant increase in peak intensity can be observed at 2923, 2849, 1508, and 1038 cm⁻¹, thereby proving the presence of the CFs in EP.

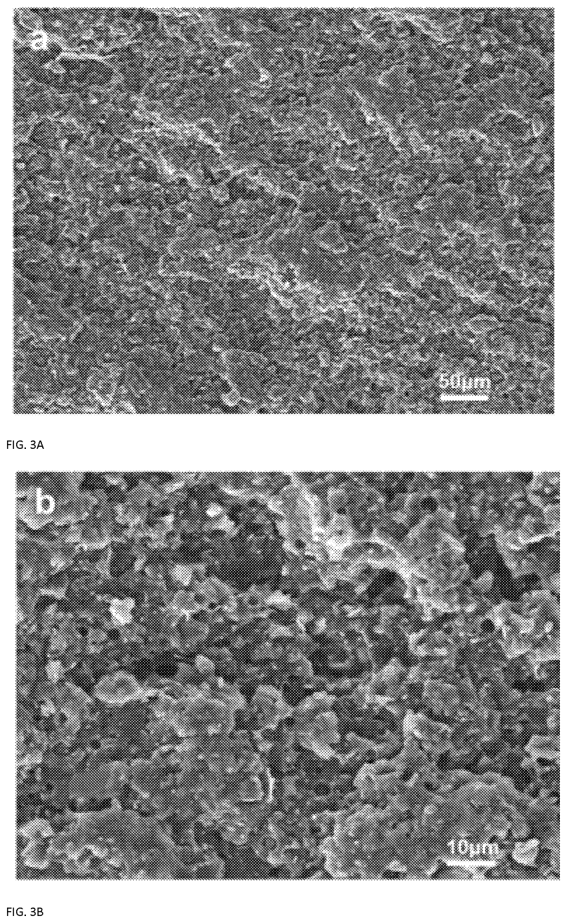

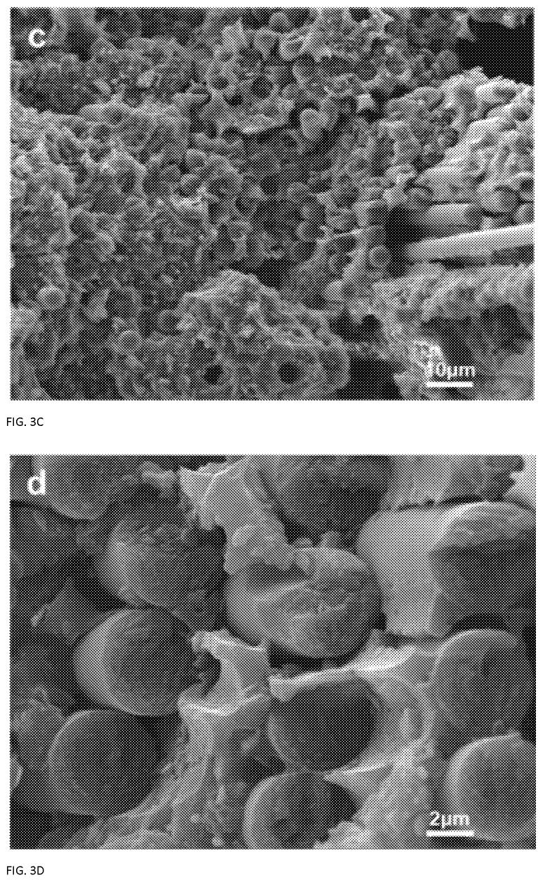

FIG. 3 shows morphology analysis, by SEM, of brittle-fracture cross-sections of the pure EP coating and the CFs@EP composite coating. As can be seen from FIG. 3A, the fracture surface of the pure EP coating is relatively flat. Upon further magnification, as shown in FIG. 3B, it can be observed that a small number of pores having relatively small sizes are still present in the pure EP coating. When the CFs are added to the epoxy resin, as shown in FIG. 3C, uneven and irregular fracture occurs on the fracture surface of the CFs@EP composite coating, because the presence of the CFs prevents directional propagation of cracks. In addition, it can be observed from the enlarged image of the fracture surface of the CFs@EP composite coating in FIG. 3D that the interfacial bonding between the CFs and EP is relatively tight, which is beneficial to improving the mechanical properties of the composite coating.

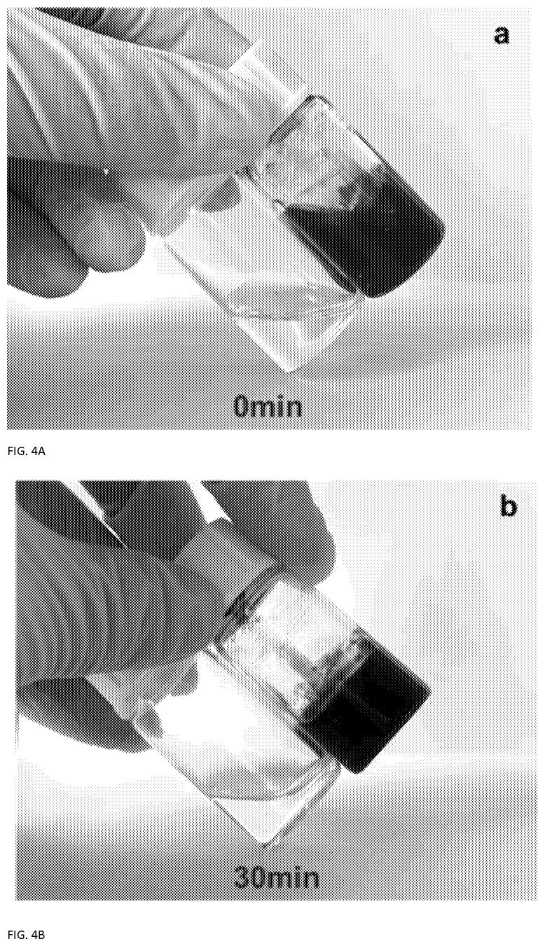

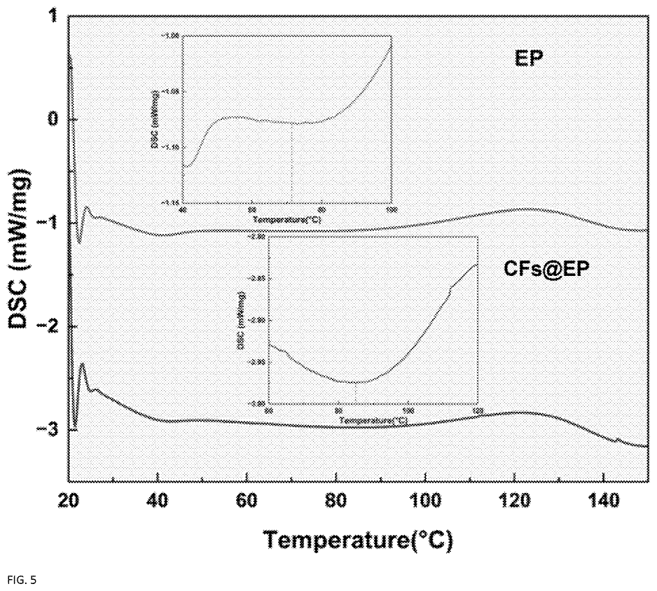

FIG. 4 is a comparison of curing time between the commercial resin reference sample used for comparison, namely Phoenix-brand E44 epoxy resin, and the CFs@EP resin. As can be seen from FIG. 4A, the commercial resin reference sample used for comparison and the CFs@EP resin both exhibited good fluidity after preparation, and were then placed upright back to their original positions. After the two resins were allowed to stand for 30 min and then tilted again, it can be seen from FIG. 4B that the CFs@EP resin had already lost fluidity, whereas the commercial resin reference sample used for comparison still exhibited good fluidity. The above results show that, under the test conditions of the present application, the CFs@EP resin has a relatively fast curing rate and exhibits an obvious reduction in fluidity within a relatively short time. In addition, under the test conditions of the present application, using substantial loss of fluidity of the resin as the criterion, the shortest curing time of the CFs@EP resin is about 25 min.

FIG. 5 shows DSC curves of the pure EP and the CFs@EP composite coating, and the corresponding glass transition temperatures were calculated. As can be seen from the figure, the glass transition temperature of the pure EP is about 72 °C, whereas the glass transition temperature of the CFs@EP composite coating is about 85 °C. This proves that the presence of the CFs significantly increases the glass transition temperature and thermal stability of the resin, which helps the CFs@EP composite coating to be applied under more severe operating conditions.

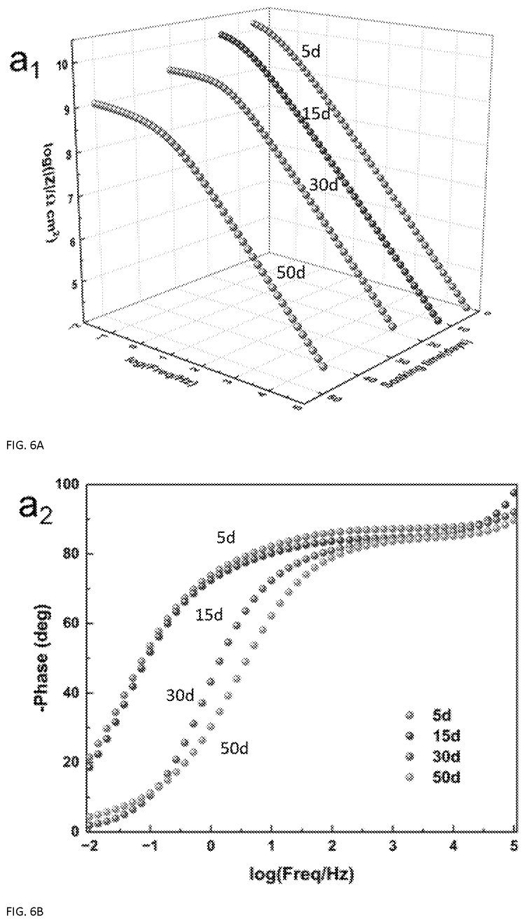

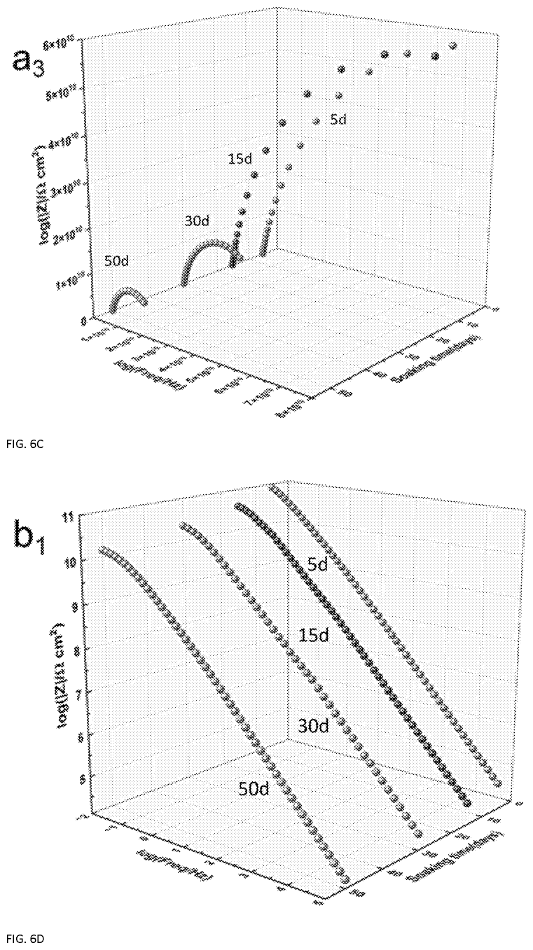

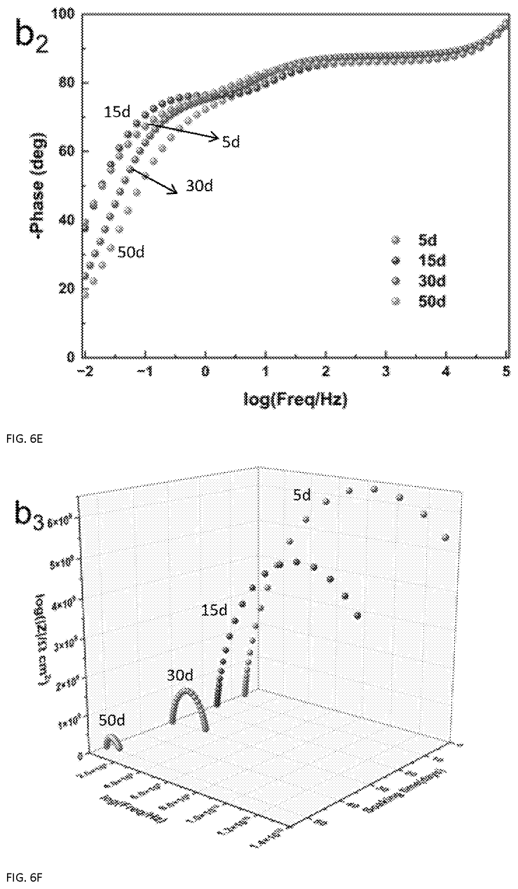

As shown in FIG. 6, electrochemical impedance spectroscopy (EIS) testing was used to evaluate the electrochemical behavior and protection mechanism of the pure EP coating and the CFs@EP composite coating. The barrier performance of a resin-based coating against corrosive media can be reflected by the impedance modulus at a specific frequency (Z_{f=0.01 Hz}). As can be seen from FIGS. 6A-6C, as the immersion time increases, the impedance of pure EP in the low-frequency region decreases over time. As shown in FIG. 6A, the initial impedance value of the pure EP was 1.49×10¹⁰ Ω·cm², and decreased to 1.08×10¹⁰ Ω·cm² after immersion for 15 days. After immersion for 30 days, the impedance modulus Z_{f=0.01 Hz} of the pure EP rapidly decreased to 2.64×10⁹ Ω·cm², indicating that corrosive particles had reached the substrate/coating interface and started to corrode the metal. As the immersion time was further prolonged, the impedance modulus of the pure EP decreased to 1.03×10⁹ Ω·cm² after 50 days. In view of microporous defects such as pores present in the pure EP coating during preparation, its resistance to electrolyte erosion is difficult to meet the practical requirements for long-term use, and therefore its anticorrosion performance is limited. Compared with the pure EP coating, the composite coating containing the CFs exhibits a higher impedance value, as shown in FIG. 6D. Specifically, the impedance modulus Z_{f=0.01 Hz} reached 8.08×10¹⁰ Ω·cm² after immersion for 5 days, was 3.90×10¹⁰ Ω·cm² after immersion for 15 days, and remained relatively stable. Over time, the impedance value decreased slightly. At an immersion time of 30 days, the low-frequency impedance value Z_{f=0.01 Hz} was 2.27×10¹⁰ Ω·cm², indicating that the electrochemical process at the metal/coating interface was greatly inhibited and that the composite coating has good protective performance. When the immersion time reached 50 days, the low-frequency impedance value of the CFs@EP composite coating still remained 1.39×10¹⁰ Ω·cm² or more. It can thus be inferred that the introduced CFs can significantly increase the anti-permeation performance of the coating and provide long-term corrosion protection capability. The corrosion degree and failure process of the substrate can be reflected by changes in the Bode phase angle plots, as shown in FIGS. 6B and 6E. Corrosion products generated at the metal substrate/coating interface may damage interfacial bonding, reduce coating adhesion, and cause coating peeling. As can be seen from FIG. 6B, as the immersion time increases, the phase angle of the pure EP coating decreases significantly after 30 days. However, during the immersion process of 50 days, the phase angle of the CFs@EP composite coating is always maintained at a relatively high position. FIGS. 6C and 6F are Nyquist plots of the pure EP coating and the CFs@EP composite coating after being present in a 3.5 wt. % NaCl solution for 50 days. The size of the capacitive arc can approximately reflect the anticorrosion performance of the coating. For the pure EP coating, its capacitive arc continuously decreases with prolonged immersion time, as shown in FIG. 6C, indicating that the anticorrosion effect of the coating on the metal is weakened. Compared with the pure EP coating, although the radius of the capacitive arc of the CFs@EP composite coating shows a decreasing trend, its capacitive-arc radius is still one order of magnitude higher than that of the pure EP. The above results again confirm that the CFs@EP composite coating has relatively excellent long-term corrosion resistance.

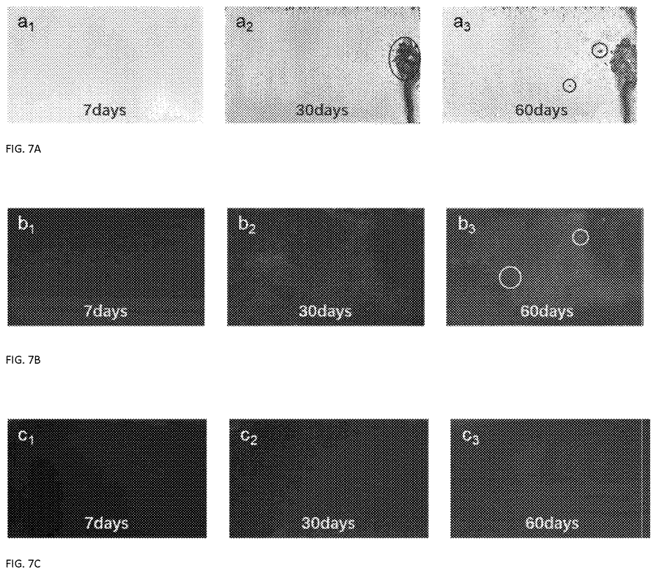

FIG. 7 shows optical photographs of different samples in the salt-spray test. As shown in FIG. 7A, after 30 days of testing, obvious pitting occurred in the commercial resin reference coating used for comparison, and a large amount of rust was generated. As the test time increased to 60 days, corrosion rust accumulated in the damaged area of the coating and covered the sample surface. This is mainly attributed to penetration and diffusion of corrosive ions in the scratched area into the coating substrate, indicating its poor barrier performance. As can be observed from FIG. 7B, a small number of white spots appeared in the pure EP coating after 30 days, and after 60 days, the coating color became lighter and was accompanied by aggregation of tiny white spots, indicating that water molecules had penetrated into the coating. However, after a 60-day neutral salt-spray test, no obvious corrosion product was found in the composite coating into which the CFs were introduced, and no obvious change occurred in the coating color, as shown in FIG. 7C. The relatively tightly arranged CFs effectively improved the barrier capability of the coating, significantly improved the anticorrosion performance of the composite coating, and effectively improved the environmental adaptability of the carbon fiber-reinforced resin-based composite coating in pipeline sealing.

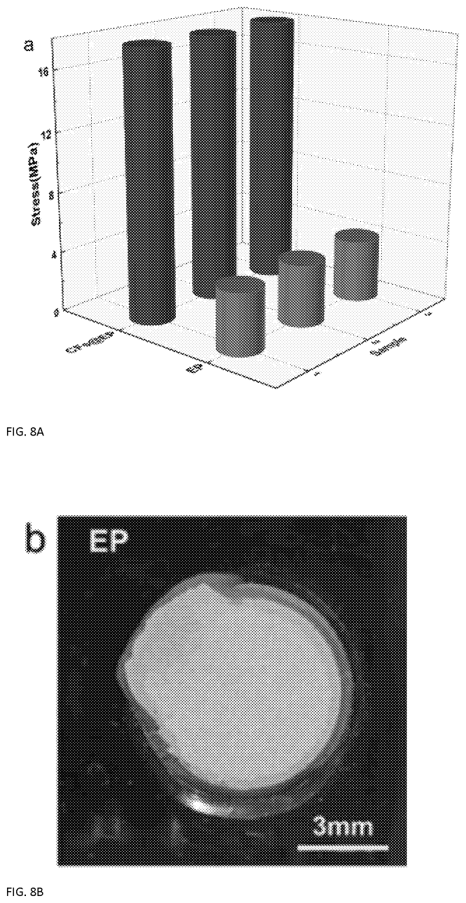

A pull-off test was used to test the adhesion of the pure EP coating and the CFs@EP composite coating on the surface of carbon steel. As can be seen from FIG. 8A, the bonding force of the pure EP coating was 4.14 MPa, whereas the bonding force of the CFs@EP composite coating reached up to 17.95 MPa, which was 3.3 times higher than that of the pure EP coating. The tightly arranged CFs were well bonded to the resin, reducing voids in the coating matrix and enhancing the interfacial bonding strength between resins. In addition, the CFs can effectively enhance the adhesion of the coating, so that the CFs@EP composite coating has superior anticorrosion performance.

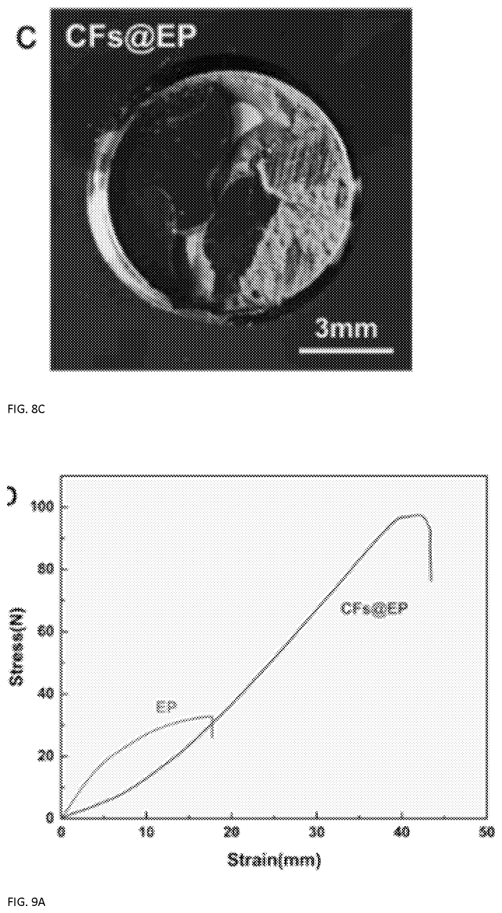

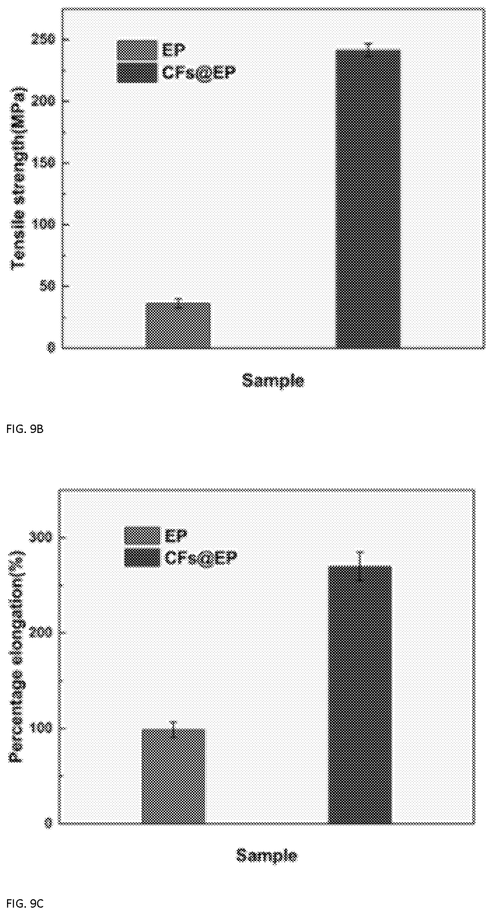

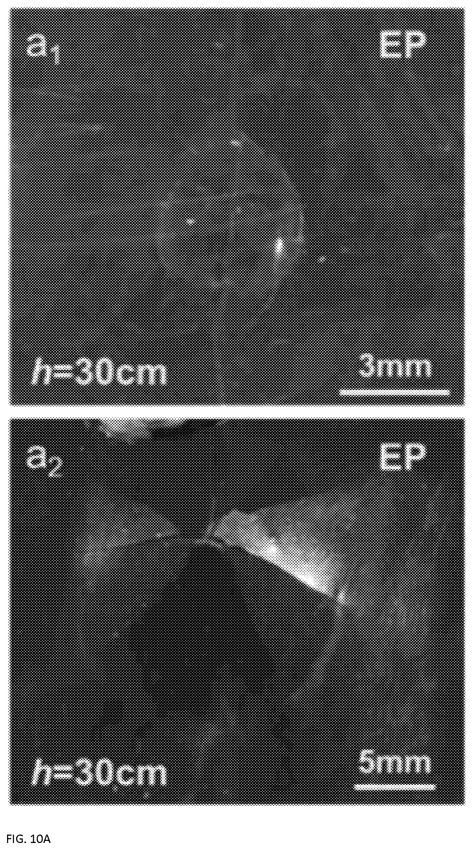

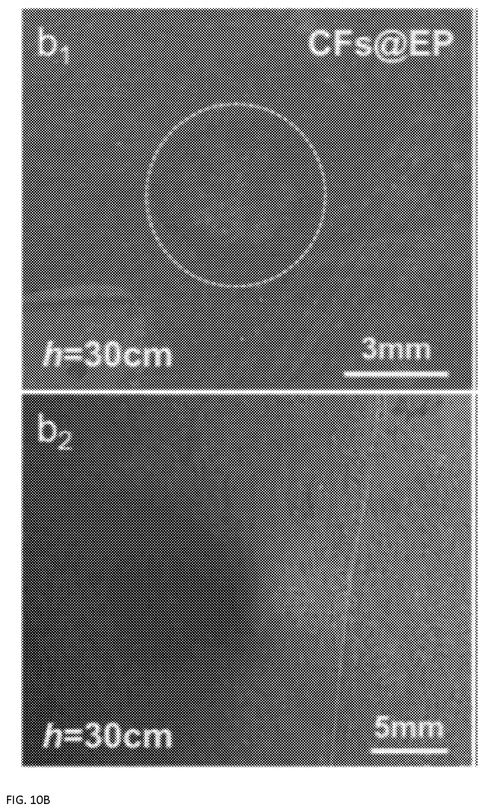

A universal material testing machine was used to conduct tensile tests on the pure EP coating and the CFs@EP composite coating, so as to evaluate the effect of the CFs on the tensile strength of the coating. The results are shown in FIGS. 9A, 9B, and 9C. The tensile strength of pure EP was 36.26 MPa, and the elongation at break was 98.58%. After the CFs were introduced, the tensile strength of the CFs@EP composite coating increased to 241.67 MPa, and the elongation at break reached 269.8%. Compared with the pure EP coating, the tensile strength and elongation at break of the CFs@EP composite coating were increased by 5.7 times and 1.7 times, respectively. Analysis shows that the high strength and toughness of the CFs themselves made a relatively large contribution to the improvement of the tensile strength of the composite coating. In addition, the presence of the CFs filled defects such as a large number of pores and cracks in the coating. Therefore, the CFs@EP composite coating has great advantages in the field of pressurized sealing of oil and gas pipelines; for example, the CFs@EP composite coating has application potential in repair, protection, and sealing applications for oil and gas pipelines.

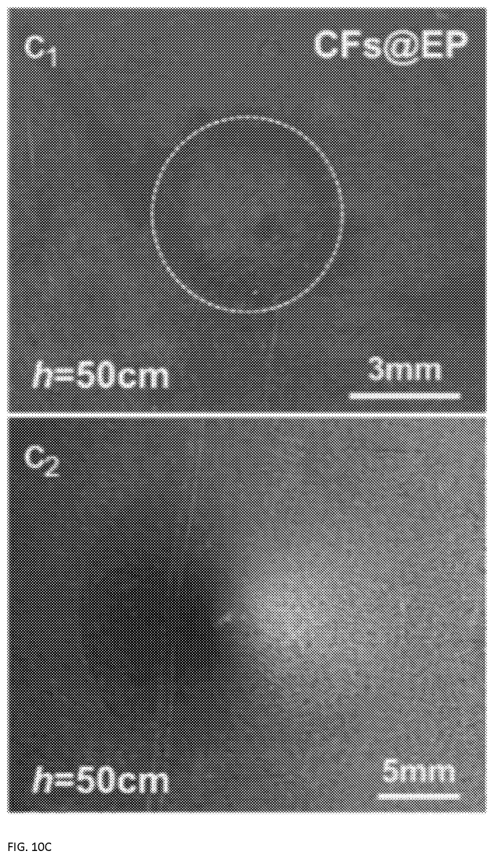

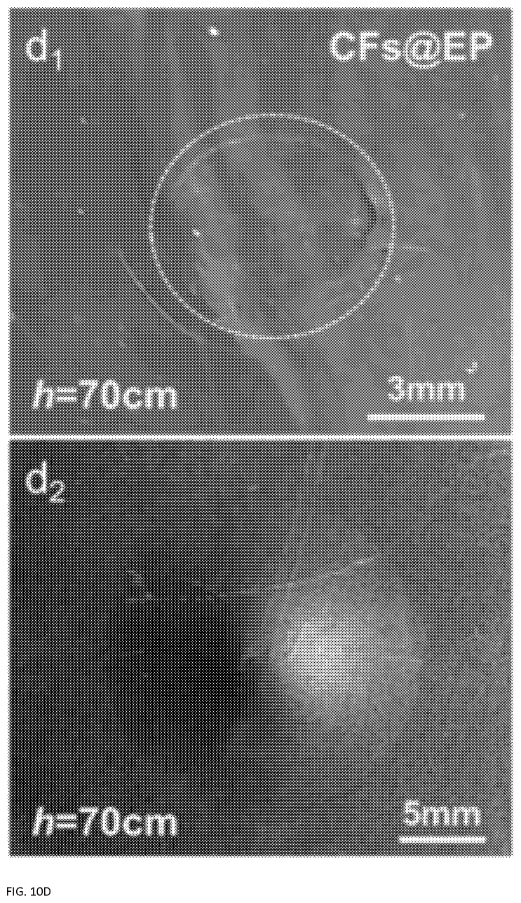

The cured epoxy resin itself has certain brittleness, and because of high crosslinking density, the coating has relatively poor crack-propagation resistance, which limits its application in rapid pipeline sealing. In view of this, the impact resistance of the pure EP coating and the CFs@EP composite coating was evaluated by a falling-weight impact test, and the results are shown in FIG. 10. As can be observed from FIG. 10A, when the impact hammer height was 30 cm, obvious cracks appeared in the pure EP coating and propagated radially outward, with a length of about 8-10 mm. By contrast, at the same falling-weight impact height, no change occurred on the surface of the CFs@EP composite coating, as shown in FIG. 10B. When the impact hammer height was further increased to 50 cm, no obvious change still occurred on the surface of the CFs@EP composite coating, as shown in FIG. 10C. When the impact hammer height was further increased to 70 cm, slight deformation could be observed at the center of the CFs@EP composite coating, but no crack was generated, as shown in FIG. 10D. The above results prove that the CFs significantly improved the brittleness problem of the coating after curing and greatly improved the impact resistance of the composite coating. The CFs@EP composite coating helps improve protection capability against mechanical damage after pipeline sealing.

The above description is only directed to preferred embodiments of the present invention, and is not intended to limit the present invention. For those skilled in the art, the present invention may have various modifications and variations. Any modification, equivalent replacement, improvement, and the like made within the spirit and principle of the present invention shall fall within the scope of protection of the present invention.

1. A carbon fiber-reinforced resin-based composite coating, comprising the following components in parts by weight: 0.5-2 parts of carbon fiber, 3-5 parts of a curing agent, 8-12 parts of an epoxy resin, 1-1.5 parts of bitumen, 1-2 parts of diaminodiphenylmethane, and 1-2 parts of glycidyl ether;
wherein the curing agent is an amine curing agent, the amine curing agent is one or more selected from the group consisting of a polyetheramine curing agent and an aliphatic amine curing agent, and the polyetheramine curing agent is one or more selected from the group consisting of D230, D400, T403, D2000, and T5000;
wherein the epoxy resin is one or more selected from the group consisting of E51 resin and E44 resin;
wherein the glycidyl ether comprises glycerol triglycidyl ether;
wherein a method for preparing the carbon fiber-reinforced resin-based composite coating comprises the following steps:
immersing the carbon fiber that has been pretreated in the curing agent to obtain a curing-agent mixture containing wetted carbon fiber;
mixing the epoxy resin, the bitumen, the diaminodiphenylmethane, and the glycidyl ether, and mixing the resulting mixture with the curing-agent mixture containing wetted carbon fiber to obtain a resin mixture; and
coating the resin mixture onto a pretreated substrate surface, and curing at room temperature to obtain the carbon fiber-reinforced resin-based composite coating.

2. The carbon fiber-reinforced resin-based composite coating of claim 1, wherein the carbon fiber comprises carbon fiber cloth;
wherein the polyetheramine curing agent is D400;
wherein the epoxy resin is E51 resin.

3. A method for preparing the carbon fiber-reinforced resin-based composite coating of claim 1, comprising the following steps:
immersing the carbon fiber that has been pretreated in the curing agent to obtain the curing-agent mixture containing wetted carbon fiber;
mixing the epoxy resin, the bitumen, the diaminodiphenylmethane, and the glycidyl ether, and mixing the resulting mixture with the curing-agent mixture containing wetted carbon fiber to obtain a resin mixture; and
coating the resin mixture onto a pretreated substrate surface, and curing at room temperature to obtain the carbon fiber-reinforced resin-based composite coating.

4. A method for preparing the carbon fiber-reinforced resin-based composite coating of claim 2, comprising the following steps:
immersing the carbon fiber that has been pretreated in the curing agent to obtain a curing-agent mixture containing wetted carbon fiber;
mixing the epoxy resin, the bitumen, the diaminodiphenylmethane, and the glycidyl ether, and mixing the resulting mixture with the curing-agent mixture containing wetted carbon fiber to obtain a resin mixture; and
coating the resin mixture onto a pretreated substrate surface, and curing at room temperature to obtain the carbon fiber-reinforced resin-based composite coating.

5. The method of claim 3, wherein the specific steps for pretreating the carbon fiber comprise:
immersing the carbon fiber in an acid solution, allowing the carbon fiber to stand, taking out the carbon fiber, and cleaning the carbon fiber, thereby obtaining the carbon fiber that has been pretreated;
wherein the acid solution has a pH of 5-6;
wherein the standing time is 6-12 h;
wherein the cleaning comprises cleaning sequentially with water and absolute ethanol.

6. The method of claim 4, wherein the specific steps for pretreating the carbon fiber comprise:
immersing the carbon fiber in an acid solution, allowing the carbon fiber to stand, taking out the carbon fiber, and cleaning the carbon fiber, thereby obtaining the carbon fiber that has been pretreated;
wherein the acid solution has a pH of 5-6;
wherein the standing time is 6-12 h;
wherein the cleaning comprises cleaning sequentially with water and absolute ethanol.

7. The method of claim 3, wherein, before pretreating the carbon fiber, the carbon fiber is further cleaned and dried.

8. The method of claim 4, wherein, before pretreating the carbon fiber, the carbon fiber is further cleaned and dried.

9. The method of claim 3, wherein, when the carbon fiber that has been pretreated is immersed in the curing agent, a standing step for sufficient mixing is performed for 1-3 h.

10. The method of claim 4, wherein, when the carbon fiber that has been pretreated is immersed in the curing agent, a standing step for sufficient mixing is performed for 1-3 h.

11. The method of claim 3, wherein the resin mixture is further required to be placed in a vacuum drying environment and evacuated for 5-10 min.

12. The method of claim 4, wherein the resin mixture is further required to be placed in a vacuum drying environment and evacuated for 5-10 min.

13. The method of claim 3, wherein the pretreated substrate surface is a substrate surface that has been subjected to pretreatment comprising polishing the substrate surface with sandpaper, cleaning the substrate surface with acetone and ethanol by ultrasonic vibration, wiping the substrate surface clean, and drying the substrate surface for later use.

14. The method of claim 4, wherein the pretreated substrate surface is a substrate surface that has been subjected to pretreatment comprising polishing the substrate surface with sandpaper, cleaning the substrate surface with acetone and ethanol by ultrasonic vibration, wiping the substrate surface clean, and drying the substrate surface for later use.

15. A pipeline, comprising the carbon fiber-reinforced resin-based composite coating of claim 1.

16. A pipeline, comprising the carbon fiber-reinforced resin-based composite coating of claim 2.

17. A pipeline, comprising a carbon fiber-reinforced resin-based composite coating obtained by the method of claim 3.

18. A pipeline, comprising a carbon fiber-reinforced resin-based composite coating obtained by the method of claim 4.
